(19) United States
(12) Patent Application Publication
(10) Pub. No.: US 2007/0154035 A1
(43) Pub. Date: Jul. 5, 2007

(54) ELECTROSTATIC ULTRASONIC TRANSDUCER, ULTRASONIC SPEAKER, SOUND SIGNAL REPRODUCING METHOD, ULTRA DIRECTIONAL ACOUSTIC SYSTEM AND DISPLAY DEVICE

(75) Inventor: Yoshiki Fukui, Suwa-shi, Nagano-ken (JP)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/538,388

(22) Filed: Oct. 3, 2006

(30) Foreign Application Priority Data
Oct. 5, 2005 (JP) 2005-292127
Jul. 11, 2006 (JP) 2006-190588
Sep. 28, 2006 (JP) 2006-265687

(51) Int. Cl. H04R 3/00; H04B 3/00

(52) U.S. Cl. 381/116; 381/191; 381/77

(57) ABSTRACT

An electrostatic ultrasonic transducer includes: a first electrode provided with a through hole; a second electrode provided with a through hole forming a pair with the through hole of the first electrode; an oscillation film sandwiched between the pair of electrodes and having an electrode layer wherein a direct current bias voltage is applied to the electrode layer, the oscillation film being driven by applying an alternating current signal between the pair of electrodes and the electrode layer; a holding member for holding the pair of electrodes and the oscillation film; electrode patterns respectively formed by lamination on the first and second electrodes corresponding to plural driving functions; and a controlling unit for carrying out control so that voltage corresponding to a driving condition defining the driving function is applied between the electrode pattern formed by lamination and the electrode layer of the oscillation film.

### BACKGROUND

1. Technical Field

The present invention relates to an electrostatic ultrasonic transducer, particularly, an electrostatic ultrasonic transducer capable of reducing influence of distortion and controlling oscillation of an oscillation film by area, an ultrasonic speaker using the electrostatic ultrasonic transducer, a method of reproducing a sound signal by means of the electrostatic ultrasonic transducer, an ultra directional acoustic system and a display device.

2. Related Art

An electrostatic ultrasonic: transducer has been usually known as a wide band oscillation type ultrasonic transducer capable of generating high sound pressure over a high frequency band. FIG. 7 shows an example of a structure of a wide band oscillation type electrostatic ultrasonic transducer. The electrostatic ultrasonic transducer 3 in FIG. 7 is called “the pull type” since it operates only in a direction that an oscillation film is pulled to a fixed electrode side.

The electrostatic ultrasonic transducer 3 shown in FIG. 7 uses a dielectric 131 (an insulator) such as PET (polyethylene terephthalate resin), which is around 3 to 10 μm in thickness, as an oscillator (an oscillation film). An upper electrode 132 formed as metallic foil such as aluminum is formed into one body with the dielectric 131 on an upper surface of the dielectric 131 in a process such as vapor deposition. A lower electrode 133 made of brass is provided so as to be in contact with a lower surface of the dielectric 131. The lower electrode 133 is connected to a lead 152 and fixed to a base plate 135 made of Bakelite or the like.

The upper electrode 132 is connected to a lead 153, which is connected to a direct current bias power source 150. Around 50 to 150 V of direct current bias voltage for adherence of the upper electrode is always applied to the upper electrode 132 from the direct current bias power source 150 so that the upper electrode 132 would adhere to a lower electrode 133 side 151 denotes a signal source.

The dielectric 131, the upper electrode 132 and the base plate 135 are fastened together with metal rings 136, 137 and 138 and a mesh 139 by means of a case 130.

On a surface of the lower electrode 133 on the dielectric 131 side, formed are plural minute grooves, which are not uniform in shape and around tens to hundreds μm in size. The minute groove forms a gap between the lower electrode 133 and the dielectric 131. Accordingly, distribution of electrostatic capacity between the upper electrode 132 and the lower electrode 133 varies slightly.

The surface of the lower electrode 133 is manually roughed by means of a rasp in order to form the random minute grooves. In an electrostatic ultrasonic transducer, forming numberless condensers different in size and depth of a gap as described above allows frequency characteristics to be in a wide band (refer to JP-A-2000-50387 and JP-A-2000-50392, for example).

As described above, the electrostatic ultrasonic transducer 3 shown in FIG. 7 has been usually known as a wide band ultrasonic transducer (of the pull type) capable of generating comparatively high sound pressure over a wide frequency band.

The maximum value of the sound pressure, however, is relatively low such as 120 dB or less, for example. This is insufficient a little in sound pressure for using the electrostatic ultrasonic transducer as an ultrasonic speaker. In order to obtain a sufficient parametric effect in an ultrasonic speaker, required is 120 dB or more of ultrasonic sound pressure. The electrostatic ultrasonic transducer (of the pull type), however, is difficult to achieve the above numerical value. Accordingly, a ceramic piezoelectric element such as PZT or a high-polymer piezoelectric element such as PVDF has been mostly used as an ultrasonic oscillator. The piezoelectric element, however, has a sharp resonance point regardless of a material and is driven at a frequency of the resonance to be put to practical use as an ultrasonic speaker. This causes an extremely small range of the frequency capable of securing high sound pressure, that is, a narrow band.

In order to solve such a problem, it is conceivable to provide an electrostatic ultrasonic transducer 4 shown in FIGS. 8A and 8B. A structure of the above is generally called a push-pull type. A push-pull type electrostatic ultrasonic transducer can simultaneously satisfy both of a wide band characteristic and the high sound pressure, differently from the pull type electrostatic ultrasonic transducer.

In FIGS. 8A and 8B, a push-pull type electrostatic ultrasonic transducer 4 comprises a pair of fixed electrodes 10 and 11 including a conductive member formed from a conductive material for functioning as an electrode, an oscillation film 12 held between the pair of fixed electrodes and including an electrode layer (a conductive layer) 121 and a member (not shown) holding the pair of fixed electrodes 10 and 11 and the oscillation film.

The oscillation film 12 is formed from an insulator 120 and includes the electrode layer 121 formed from a conductive material. Direct current bias voltage with single polarity (which may be any one of positive and negative polarities) is arranged to be applied to the electrode layer 121 from a direct current bias power source 16.

The pair of fixed electrodes 10 and 11 are provide with plural through holes (through holes with a step) 14, which are equal in number between the electrodes, so that the through holes would be opposed to each other with respect to the oscillation film 12. It is arranged that alternating current signals be applied between the conductive members of the pair of fixed electrodes 10 and 11 from the signal sources 18A and 18B. Condensers are provided between the fixed electrode 10 and the electrode layer 121 and between the fixed electrode 11 and the electrode layer 121, respectively.

In the above structure, in the ultrasonic transducer 4, the direct current bias voltage with single polarity (which is positive polarity in the first embodiment) is applied to the electrode layer 121 of the oscillation film 12 from the direct current bias power source 16. On the other hand, alternating current signals are applied from the signal sources 18A and 18B to the pair of the fixed electrodes 10 and 11. As a result, positive voltage is applied to the fixed electrode 10 in a positive half cycle of the alternating current signals outputted from the signal sources 18A and 18B, so that electrostatic force of repulsion operates on a surface part 12A, which is not held between the fixed electrodes of the oscillation film 12. Accordingly, the surface part 12A is pulled downward in FIG. 8A. At that time, application of negative voltage on the opposite fixed electrode 11 causes electrostatic attraction operating on a back surface part 12B, which is a back surface side of the surface part 12A of the oscillation film 12, so that the back surface part 12B is further pulled downward in FIG. 8A.

Accordingly, the film part, which is not held between the pair of fixed electrodes 10 and 11 of the oscillation film 12, receives the electrostatic repulsive force and the electrostatic attraction in the same direction. This is true of a negative half cycle of the alternating current signals outputted from the signal sources 18A and 18B. The electrostatic attractive force operates on the surface part 12A of the oscillation film 12 upward in FIG. 8A while the electrostatic repulsive force operates on the back surface part 12B upward in FIG. 8A. The film part, which is not held between the pair of fixed electrodes 10 and 11 of the oscillation film 12, thus receives the electrostatic repulsive force and the electrostatic attraction in the same direction. As described above, the oscillation film 12 receives the electrostatic repulsive force and the electrostatic attractive force in the same direction while the direction that the electrostatic force operates alternately varies in accordance with the change in polarity of the alternating current signal. This allows large film oscillation, namely, an acoustic signal at an enough sound pressure level to obtain the parametric array effect to be generated.

The ultrasonic transducer 4 is called a push-pull type since the oscillation film 12 receives force from the pair of fixed electrodes 10 and 11 to oscillate, as described above. The push-pull type electrostatic ultrasonic transducer 4 is capable of simultaneously satisfying the wide band characteristic and the high sound pressure, differently from a pull type electrostatic ultrasonic transducer in which the electrostatic attractive force only operates on the oscillation film.

In the ultrasonic transducer 4 shown in FIGS. 8A and 8B, the fixed electrodes 10 and 11 may be formed from a single body such as SUS, brass, iron and nickel, for example, so long as materials of the fixed electrodes 10 and 11 have conductivity. Further, a plating process with nickel, gold, silver or copper may be performed after a desired drilling process is carried out for a glass epoxy board or a paper phenol board, which is generally used for a circuit substrate, since reducing in weight is required. In this case, performing the plating process on the both surfaces of a board is effective for the purpose of preventing a warp after shaping the substrate. In view of insulation, however, some insulating process is preferably carried out on the oscillation film side of the respective fixed electrodes. For example, formed is a convex insulated by means of a liquid solder resist, a photosensitive film, a photosensitive coating material, a nonconductive coating or an electrodeposition material.

As described above, in a push-pull type electrostatic ultrasonic transducer, high direct current bias voltage is applied to the oscillation film while alternating current voltage is applied to the fixed electrode. This causes the film part to oscillate due to electrostatic force (attractive force and repulsive force) operating on the fixed electrode and the oscillation film. In this case, a diameter of a hole of the oscillation part should be several millimeters or less in order to achieve oscillation in an ultrasonic band. Accordingly, it is necessary to provide plural oscillation holes to form a transducer with an improved following characteristic and a large output.

In the driving method used in the above structure, however, oscillation force does not operate between the respective oscillation holes (an area pressed from the upper and lower sides by the fixed electrodes) in the oscillation film or the oscillation film is not fixed in the area. This causes a problem that the oscillation film skids in the case that distance between the respective oscillation holes is short. When the oscillation film goes into such a skid, distortion due to oscillation occurs in an acoustic signal generated from the oscillation film, so that the sound quality is deteriorated.

As described above, in the push-pull type electrostatic ultrasonic transducer shown in FIGS. 8A and 8B, occurs a problem that oscillation force does not operate between the respective oscillation holes (in an area pressed from the upper and lower sides by the fixed electrodes) in the oscillation film or the oscillation film is not fixed in the area and the oscillation film skids in the case of short distance between the respective oscillation holes. The skid of the film causes a problem of distortion due to oscillation of the oscillation film.

### SUMMARY

An advantage of some aspects of the invention is to provide an electrostatic ultrasonic transducer in which an area other than an oscillation part of the oscillation film (a non-oscillation area) is fixed only by means of electrostatic force to improve a mutual independent characteristic of oscillation holes arranged in an array, to allow influence of distortion due to oscillation of the film oscillation to be reduced, to allow oscillation control for the oscillation film area by area, and further, to allow directional control by partially phase-controlling drive of the oscillation holes arranged in an array, an ultrasonic speaker using the electrostatic ultrasonic transducer, a method of reproducing a sound signal by means of the electrostatic ultrasonic transducer, an ultra directional acoustic system and a display device.

An ultrasonic transducer according to an aspect of the invention includes: a first electrode including a through hole and plural electrode patterns; a second electrode including a through hole forming a pair with the through hole of the first electrode and plural electrode patterns forming a pair with the electrode patterns; an oscillation film including an electrode layer and sandwiched between a pair of electrodes formed from the first electrode and the second electrode; and a controlling unit for applying voltage between the electrode patterns of the pair of electrodes and the electrode layer of the oscillation film to drive the oscillation film under plural driving conditions.

In accordance with such a structure, in a push-pull type electrostatic ultrasonic transducer (the push-pull type electrostatic ultrasonic transducer shown in FIG. 1, for example), electrode patterns corresponding to plural driving functions are formed by lamination on each of the pair of electrodes (the fixed electrodes 10 and 11 shown in FIG. 1, for example) having plural through holes (the electrode patterns of the electrodes for oscillation 101 and 111 and the electrodes for fixing 102 and 112, which are shown in FIG. 1, are formed by lamination, for example). Voltage corresponding to the driving function is then applied between each electrode pattern and the electrode layer of the oscillation film (the electrode layer 121 shown in FIG. 1, for example).

This allows the electrode patterns of the pair of electrodes to be formed into plural layers in a push-pull type electrostatic ultrasonic transducer, and thereby, oscillation to be controlled for the oscillation film area by area. For example, fixing an area other than the oscillation part (the non-oscillation area) of the oscillation film only by electrostatic force allows influence of distortion of the oscillation film to be reduced.

In an electrostatic ultrasonic transducer according to another aspect of the invention, the electrode may include: an electrode pattern for oscillation for oscillating the oscillation film; and a pattern of an electrode for fixing for fixing the oscillation film to the pair of electrodes, and the controlling unit applies voltage between the electrode layer of the oscillation film and the electrode pattern for fixing so that a part of the oscillation film would be fixed to the pair of electrodes in oscillating the oscillation film.

In accordance with such a structure, in a push-pull type electrostatic ultrasonic transducer (the push-pull type electrostatic ultrasonic transducer shown in FIG. 1, for example), a pattern of an electrode for oscillation for oscillating an oscillation part of the oscillation film (an oscillation area of the oscillation film opposed to the through hole of the fixed electrode) and a pattern of an electrode for fixing for fixing a non-oscillation part (the non-oscillation area) of the oscillation film to the pair of electrodes are formed on the pair of electrodes (the fixed electrodes 10 and 11 shown in FIG. 1, for example) having plural through holes (the electrode patterns of the electrodes for oscillation 101 and 111 and the electrodes for fixing 102 and 112, which are shown in FIG. 1, are formed, for example). An alternating current signal is then applied between the electrode layer of the oscillation film and the pattern of an electrode for oscillation to oscillate the oscillation film while direct current voltage is applied between the electrode layer of the oscillation film and the pattern of an electrode for fixing to fix the non-oscillation area of the oscillation film to the pair of electrodes.

This allows an area other than the oscillation part (the non-oscillation area) of the oscillation film to be fixed only by electrostatic force and influence of distortion to be reduced.

In an electrostatic ultrasonic transducer according to another aspect of the invention, the electrode pattern for oscillation is divided so that the oscillation film would be divided into plural blocks for drive and the controlling unit controls a phase of an alternating current signal applied between the electrode layer of the oscillation film and each block of the electrode pattern for oscillation so as to give a predetermined difference in phase between the respective adjacent blocks in oscillating the oscillation film.

In accordance with such a structure, in a push-pull type electrostatic ultrasonic transducer, a film oscillation part of the oscillation film (an oscillation area of the oscillation film opposed to the through hole of the fixed electrode) is divided into plural blocks and the pattern of an electrode for oscillation are divided so as to correspond to the respective blocks. Phases of alternating current signals are then controlled so that acoustic signals different in phase per a block unit would be outputted. The phase-controlled alternating current signals are applied to the respective divided electrode patterns to control a direction of a sound radiated from the electrostatic ultrasonic transducer.

This allows directional control to be performed in an electrostatic ultrasonic transducer.

An electrostatic ultrasonic transducer according to another aspect of the invention includes: an electrode including plural electrode patterns and including convex and concave parts on the surface thereof; an oscillation film including an electrode layer and held on the surface of the electrode; and a controlling unit for applying voltage between the electrode,pattern of the electrode and the electrode layer of the oscillation film to drive the oscillation film under plural driving conditions.

In accordance with such a structure in a push-pull type electrostatic ultrasonic transducer (the push-pull type electrostatic ultrasonic transducer shown in FIGS. 4A to 4D, for example), electrode patterns are formed on the electrode (the fixed electrode 11 shown in FIGS. 4A to 4D, for example) having plural concave parts (or through holes) by lamination by driving function (the electrode patterns of the electrode for oscillation 111 and the electrode for fixing 112, which are shown in FIGS. 4A to 4D, for example, are formed into multi-layers). Voltage corresponding to the driving function is then applied between the respective electrode patterns and the electrode layer of the oscillation film (the electrode layer 121 shown in FIGS. 4A to 4D, for example).

This allows electrode patterns of a pair of electrodes to be formed into plural layers in a pull type electrostatic ultrasonic transducer, and thereby, oscillation to be controlled for the oscillation film by area. For example, fixing an area other than the oscillation part (the non-oscillation area) of the oscillation film only by electrostatic force allows influence of distortion due to film oscillation to be reduced.

In an electrostatic ultrasonic transducer according to another aspect of the invention, the electrode includes: an electrode pattern for oscillation for oscillating the oscillation film; and an electrode pattern for fixing for fixing the oscillation film to the electrode, and the controlling unit applies voltage between the electrode layer of the oscillation film and the electrode pattern for fixing so that a part of the oscillation film would be fixed to the electrode in driving the oscillation film.

In accordance with such a structure, in a push-pull type electrostatic ultrasonic transducer (the push-pull type electrostatic ultrasonic transducer shown in FIGS. 4A to 4D, for example), a pattern of an electrode for oscillation for oscillating an oscillation part of the oscillation film (an oscillation area of the oscillation film opposed to the concave part of the electrode) and a pattern of an electrode for fixing for fixing a non-oscillation area of the oscillation film are formed on the electrode (the fixed electrode 11 shown in FIGS. 4A to 4D, for example) having plural through holes (the electrode patterns of the electrode for oscillation 111 and the electrode for fixing 112, which are shown in FIGS. 4A to 4D, are formed, for example). An alternating current signal is then applied between the electrode layer of the oscillation film and the pattern of an electrode for oscillation to oscillate the oscillation film while direct current voltage is applied between the electrode layer of the oscillation film and the pattern of an electrode for fixing to fix the non-oscillation area of the oscillation film.

This allows an area other than the oscillation part (the non-oscillation area) of the oscillation film to be fixed only by electrostatic force and influence of distortion due to film oscillation to be reduced.

In an electrostatic ultrasonic transducer according to another aspect of the invention, the electrode pattern for oscillation is divided so that the oscillation film would be divided into plural blocks for drive and the controlling unit controls a phase of an alternating current signal applied between the electrode layer of the oscillation film and each block of the electrode pattern for oscillation so as to give a predetermined difference in phase between the respective adjacent blocks in oscillating the oscillation film.

In accordance with such a structure, in a pull type electrostatic ultrasonic transducer, a film oscillation part of the oscillation film (an oscillation area of the oscillation film opposed to the concave part of the electrode) is divided into plural blocks and the pattern of an electrode for oscillation is divided so as to correspond to the respective blocks. Phases of alternating current signals are then controlled so that an acoustic signal different in phase per a block unit is outputted. The phase-controlled alternating current signals are applied to the respective divided electrode patterns to control a direction of a sound radiated from the electrostatic ultrasonic transducer.

This allows directional control to be performed in the electrostatic ultrasonic transducer.

An ultrasonic speaker according to an aspect of the invention includes the electrostatic ultrasonic transducer described in any of the above.

This allows the ultrasonic speaker with reduced influence of distortion to be provided. Further, provided can be an ultrasonic speaker capable of control of a direction.

A method of reproducing a sound signal by means of an electrostatic ultrasonic transducer in accordance with an aspect of the invention uses the electrostatic ultrasonic transducer described in any of the above, and the method includes: generating a signal wave in an audible frequency band by means of a signal source; generating a carrier wave in an ultrasonic frequency band by means of a carrier wave supplying source; generating a modulated signal obtained by modulating the carrier wave with the signal wave in the audible frequency band; and applying the modulated signal between the electrode and the electrode layer of the oscillation film to drive the electrostatic ultrasonic transducer.

In accordance with the method of reproducing a sound signal by means of an electrostatic ultrasonic transducer including such processes, a signal wave in an audible frequency band is generated by means of a signal source and a carrier wave in an ultrasonic frequency band is generated and outputted by means of a carrier wave supplying source. The carrier wave is then modulated with the signal wave in the audible frequency band. The modulated signal is applied between the electrode and the electrode layer of the oscillation film to drive the electrostatic ultrasonic transducer.

This allows the electrostatic ultrasonic transducer having such a structure to reduce influence of distortion due to film oscillation, to increase the film oscillation, to output an acoustic signal, which is at a sound pressure level high enough for obtaining a parametric array effect over a wide frequency band and which is reduced in distortion, and to reproduce a sound signal.

An ultra directional acoustic system in accordance with an aspect of the invention is an ultra directional acoustic system for reproducing a sound signal supplied from an acoustic source to form a virtual sound source in the vicinity of a sound wave reflection surface such as a screen by means of an ultrasonic speaker using the electrostatic ultrasonic transducer described in any of the above, the ultra directional system includes: an ultrasonic speaker for reproducing a signal in a middle and high sound range among sound signals supplied from the acoustic source; and a low-sound reproducing speaker for reproducing a sound in a low sound range among the sound signals supplied from the acoustic source.

In accordance with the ultra directional acoustic system having such a structure, used is an ultrasonic speaker using the electrostatic ultrasonic transducer described in any of the above. The ultrasonic speaker is used for reproducing a sound signal in a middle and high sound range among sound signals supplied from the acoustic source. A sound signal in a low sound range among sound signals supplied from the acoustic source is reproduced by means of the low-sound reproducing speaker.

Accordingly, a sound in a middle and high sound range can be reproduced with a sufficient sound pressure and a wide band characteristic so as to be generated from a virtual sound source formed in the vicinity of a sound wave reflection surface such as a screen while influence due to film oscillation in the electrostatic ultrasonic transducer is reduced. A sound in a low sound range is directly outputted from a low-sound reproducing speaker provided in the acoustic system, so that a low sound range can be reinforced, and thereby, a sound environment with high sense of presence can be created.

A display device in accordance with an aspect of the invention includes the electrostatic ultrasonic transducer described in any of the above, and has: an ultrasonic speaker for reproducing a signal sound in an audible frequency band from sound signals supplied from an acoustic source; and a projection optical system for projecting an image on a projection surface.

In the display device having such a structure, used is an ultrasonic speaker comprising the electrostatic ultrasonic transducer described in any of the above. The ultrasonic speaker reproduces a sound signal supplied from an acoustic source.

This allows an acoustic signal to be reproduced with a sufficient sound pressure and a wide band characteristic so as to be generated from a virtual sound source formed in the vicinity of a sound wave reflection surface such as a screen. Accordingly, control of a reproduction range of an acoustic signal can be easily performed. Furthermore, a direction of a sound radiated from the ultrasonic speaker can be controlled.

### BRIEF DESCRIPTION OF THE DRAWINGS

The invention will be described with reference to the accompanying drawings, wherein like numbers-reference like elements.

FIGS. 1A, 1B and 1C show an ultrasonic transducer in accordance with a first embodiment of the invention.

FIG. 2 shows an example of signal connection in the electrostatic ultrasonic transducer shown in FIGS. 1A, 1B and 1C.

FIGS. 3A and 3B show an ultrasonic transducer in accordance with a second embodiment of the invention.

FIGS. 4A, 4B, 4C and 4D show an electrostatic ultrasonic transducer in accordance with a third embodiment of the invention.

FIG. 5 shows an example of a structure for controlling a direction of an electrostatic ultrasonic transducer.

FIG. 6 shows an example of a structure of an ultrasonic speaker.

FIG. 7 shows an example of a structure of a pull type electrostatic ultrasonic transducer.

FIGS. 8A and 8B show an example of a structure of a push-pull type electrostatic ultrasonic transducer.

FIG. 9 illustrates a condition of using a projector in accordance with an embodiment of the invention.

FIGS. 10A and 10B show a structure in external appearance of a projector shown in FIG. 12.

FIG. 11 is a block diagram showing an electric structure of a projector shown in FIG. 12.

FIG. 12 illustrates reproduction of a reproduced signal by means of an ultrasonic transducer.

### DESCRIPTION OF EXEMPLARY EMBODIMENTS

### First Embodiment

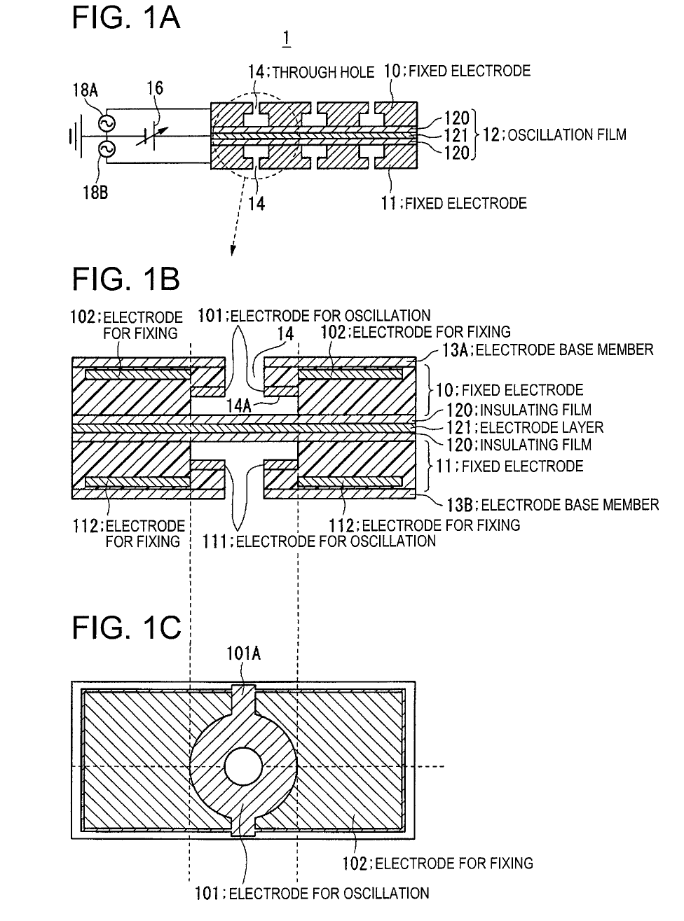

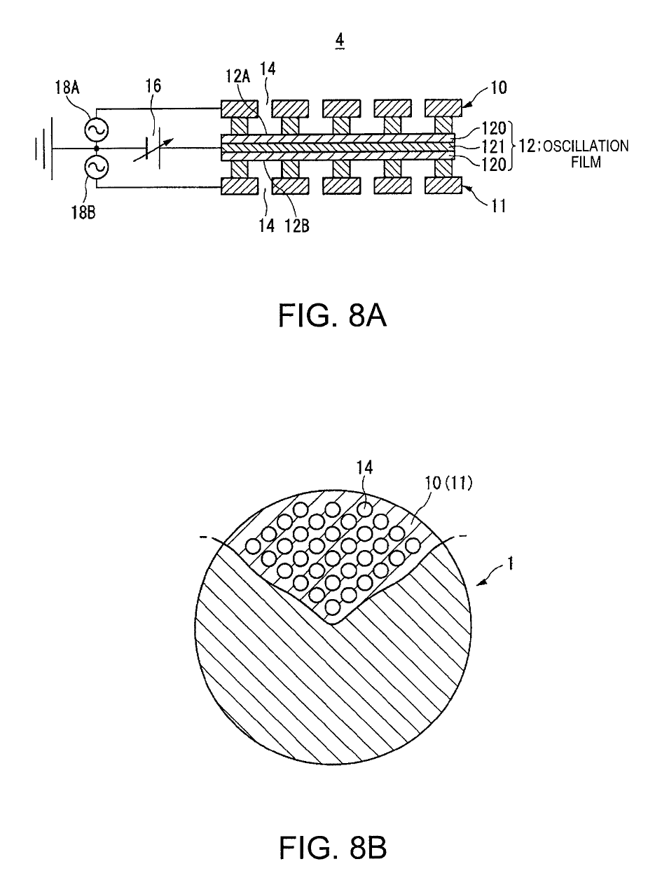

FIGS. 1A, 1B and 1C show an ultrasonic transducer in accordance with a first embodiment of the invention. An example shown in FIGS. 1A, 1B and 1C is an example of applying the invention to a push-pull type electrostatic ultrasonic transducer. FIG. 1A shows a whole structure of a push-pull type electrostatic ultrasonic transducer. The electrostatic ultrasonic transducer 1 shown in FIG. 1A has a structure basically same as that of the electrostatic ultrasonic transducer shown in FIGS. 8A and 8B, which is described above. In the ultrasonic transducer shown in FIGS. 1A, 1B and 1C, however, plural electrode patterns are formed in the fixed electrodes 10 and 11 and the fixed electrodes 10 and 11 are formed from an insulating material for the purpose of forming plural electrode patterns.

FIG. 1B is a partially enlarged view of FIG. 1A. FIG. 1B shows an example of arrangement of the electrodes for oscillation and the electrodes for fixing as the plural electrode patterns. FIG. 1C shows a relation in arrangement between the electrodes for oscillation and the electrodes for fixing. FIG. 1C is a top view of the electrostatic ultrasonic transducer 1 shown in FIGS. 1A and 1B.

As shown in FIG. 1B, in the push-pull type electrostatic ultrasonic transducer 1, an electrode for oscillation 101 is provided in the upper fixed electrode 10 so as to correspond to the shape of each oscillation hole (with a through hole). The electrode for oscillation 101 is connected to each other to form a piece of electrode pattern. That is to say, an electrode for oscillation 101 is provided on a band-shaped annular surface 14A formed in a through hole 14 due to a difference in level between the through hole with a small diameter and the through hole with a large diameter inside the through hole (a through hole with a step) 14 of the fixed electrode 10. The electrode for oscillation 101 is formed into an annular electrode pattern as shown in FIG. 1C. A band-shaped part 101A extending from the electrode for oscillation 101 is a part to be a wiring pattern for connection with the electrode for oscillation 101 of the adjacent through hole 14.

In a part other than the through hole 14 of the upper fixed electrode 10, provided is an electrode for fixing 102 at a place in no contact with the electrode for oscillation 101. The electrode for oscillation 101 and the electrode for fixing 102 are not provided on the same plane but separately provided on the upper and lower planes so as to sandwich an insulating member. Similarly, the lower fixed electrode 11 is provided with an electrode for oscillation 111 at the part where the through hole 14 is provided. At a part other than the through hole 14, provided is an electrode for fixing 112. The electrode for oscillation 111 and the electrode for fixing 112 are not provided on the same plane but separately provided on the upper and lower planes so as to sandwich an insulating member. Such a structure allows the electrodes for oscillation 101 and 111 and the electrodes for fixing 102 and 112 to be independent, respectively, and thereby, drive of the electrodes for oscillation 101 and 111 and the electrodes for fixing 102 and 112 to be partially separated.

An electrode base member 13A provided on the upper surface of the electrostatic ultrasonic transducer 1 and an electrode base member 13B provided on the lower surface are base member for covering and protecting the fixed electrodes 10 and 11. They have no direct relation with an operation of the invention.

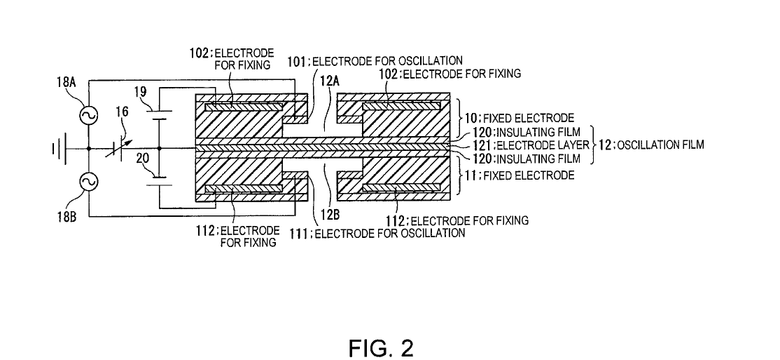

FIG. 2 shows an example of signal connection in the electrostatic ultrasonic transducer shown in FIGS. 1A, 1B and 1C. As shown in the example of signal connection in FIG. 2, direct current voltage with single polarity (which is positive polarity in the first embodiment) is applied to an electrode for fixing 102 in the upper fixed electrode 10 for an electrode layer 121 of an oscillation film 12 from a direct current power source 19. On the other hand, direct current voltage with single polarity (which is positive polarity in the first embodiment) is applied to an electrode for fixing 112 in the lower fixed electrode 11 for the electrode layer 121 of the oscillation film 12 from a direct current power source 20. This causes electrostatic attraction to operate between the electrode layer 121 of the oscillation film 12 and the electrode for fixing 102 and also between the electrode layer 121 of the oscillation film 12 and the electrode for fixing 112. Accordingly, the non-oscillation area of the oscillation film 12 can be fixed to the fixed electrodes 10 and 11 by means of the electrostatic force.

Between the electrode layer 121 of the oscillation film 12 and the electrodes for fixing 101 and 102, applied is direct current bias voltage with single polarity (which is positive polarity in the first embodiment) from a direct current bias power source 16. An alternating current signal outputted from the signal source 18A is applied to the electrode for oscillation 101 in a state that the direct current bias voltage is superimposed thereon. Similarly, an alternating current signal outputted from the signal source 18B is applied to the electrode for oscillation 111 in a state that the direct current bias voltage is superimposed thereon.

As a result, positive voltage is applied to the electrode for oscillation 101 in a positive half cycle of the alternating current signals outputted from the signal sources 18A and 18B, so that electrostatic force of repulsion operates on a surface part 12A, which is not held between the fixed electrodes of the oscillation film 12. The surface part 12A is thus pulled downward in FIG. 2.

At that time, application of negative voltage on the opposite electrode for oscillation 111 causes electrostatic attraction to be operated on a back surface part 12B, which is a back surface side of the surface part 12A of the oscillation film 12, so that the back surface part 12B is further pulled downward in FIG. 2. Accordingly, the film part, which is not held between the pair of fixed electrodes 10 and 11 of the oscillation film 12, receives the electrostatic repulsive force and the electrostatic attractive force in the same direction.

This is true of a negative half cycle of the alternating current signals outputted from the signal sources 18A and 18B. The electrostatic attractive force operates on the surface part 12A of the oscillation film 12 upward in FIG. 2 while the electrostatic repulsive force operates on the back surface part 12B upward in FIG. 2. The film part, which is not held between the pair of fixed electrodes 10 and 11 of the oscillation film 12, thus receives the electrostatic repulsive force and the electrostatic attractive force in the same direction.

The oscillation film 12 receives the electrostatic repulsive force and the electrostatic attractive force in the same direction while the direction that the electrostatic force operates alternately varies in accordance with the change in polarity of the alternating current signal, as described above. This allows large film oscillation, namely, an acoustic signal at an enough sound pressure level to obtain the parametric array effect to be generated.

As described above, in the first embodiment shown in FIG. 1, fixing an area other than the oscillation part of the oscillation film 12 by means of electrostatic force allows a mutual independent characteristic of oscillation holes arranged in the shape of an array (an oscillation area of the oscillation film opposed to the through hole 14 of the fixed electrode) to be improved and influence of distortion to be reduced.

A value of the direct current voltage applied between the oscillation film 12 and the electrodes for fixing 102 and 112 may be adjusted to adjust electrostatic force to be applied between the electrode layer 121 of the oscillation film 12 and the electrodes for fixing 102 and 112 so that the outer circumference of the film oscillation part of the oscillation film 12 is changed from a fixed end to a free end. This allows the film oscillation to be increased.

### Second Embodiment

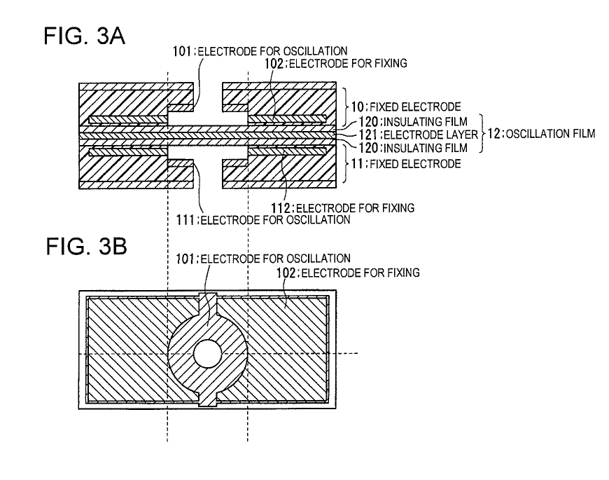

FIGS. 3A and 3B show an electrostatic ultrasonic transducer in accordance with a second embodiment of the invention. An example shown in FIGS. 3A and 3B is an example of arrangement of the electrodes for fixing 102 and 112, which are provided more closely to the oscillation film 12 than the case of the first embodiment shown in FIGS. 1A to 1C. Such arrangement allows the direct current voltage necessary to fix the electrodes for fixing 102 and 112 and the oscillation film 12 by means of electrostatic force to be made small.

### Third Embodiment

The electrostatic ultrasonic transducer in accordance with the embodiments of the invention can be achieved not only by a push-pull type electrostatic ultrasonic transducer but also by a pull type electrostatic ultrasonic transducer.

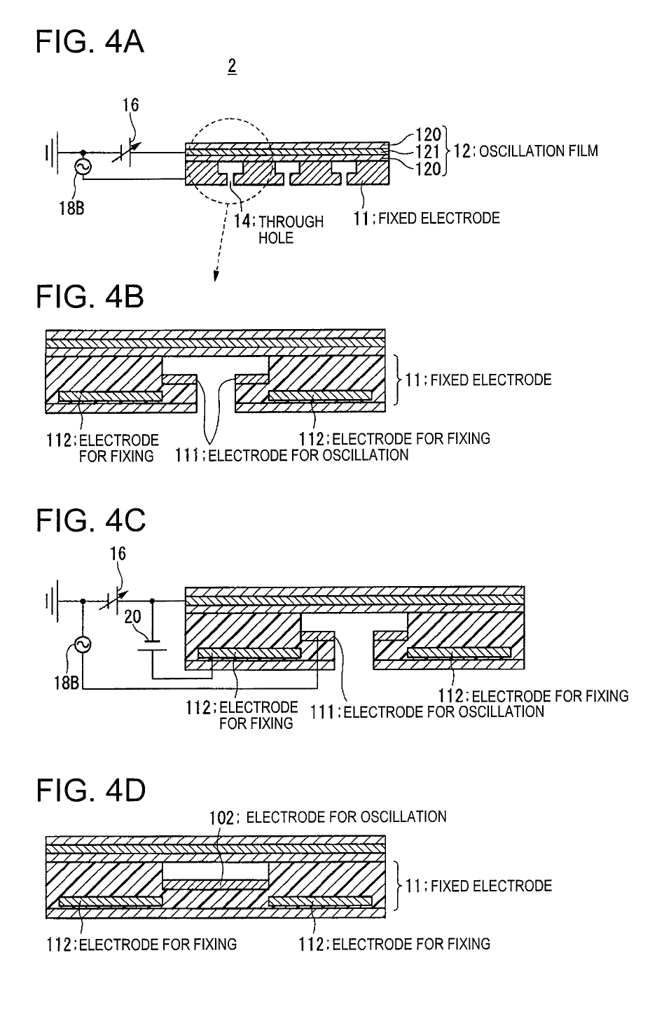

FIGS. 4A, 4B, 4C and 4D show an electrostatic ultrasonic transducer in accordance with a third embodiment of the invention. FIGS. 4A, 4B, 4C and 4D show an example of forming a pull type electrostatic ultrasonic transducer.

FIG. 4A shows a whole structure of an electrostatic ultrasonic transducer 2. FIG. 4B is a partially enlarged view of FIG. 4A and shows an example of arrangement of an electrode for oscillation and an electrode for fixing. FIG. 4C shows an example of signal connection. FIG. 4D shows a modification of the fixed electrode 11.

An example shown in FIGS. 4A, 4B, 4C and 4D is an example of a structure in which the upper fixed electrode 10 of the electrostatic ultrasonic transducer 1 shown in FIGS. 1A to 1C is removed. Further, in the structure shown in FIGS. 4A, 4B, 4C and 4D, compared with the ultrasonic transducer 3 shown in FIG. 7, a concave part of the fixed electrode 133 having concave and convex parts, the fixed electrode 133 being shown in FIG. 7, is replaced with a through hole 14 shown in FIGS. 4A, 4B, 4C and 4D. Such a structure allows circulation of the air to be improved due to the through hole 14, and thereby, efficiency in radiation of an acoustic signal from the oscillation film 12 to be improved. The fixed electrode 11 shown in FIGS. 4A to 4D may be replaced with one similar to the fixed electrode 133 having the convex and concave parts shown in FIG. 7 to form a structure shown in FIG. 4D.

The example shown in FIGS. 4A, 4B, 4C and 4D is just a pull type electrostatic ultrasonic transducer formed by removing the upper fixed electrode 10 of the electrostatic ultrasonic transducer 1 shown in FIGS. 1A to 1C. Functions and operations of the electrode for oscillation 111 and the electrode for fixing 112 are similar to those in the case shown in FIGS. 1A to 1C. The description thereof is thus omitted.

### Fourth Embodiment

In the electrostatic ultrasonic transducer in accordance with a fourth embodiment of the invention, electrode patterns multi-layered by driving function are provided on the fixed electrodes so that the voltage corresponding to the driving function can be applied to the respective electrode patterns. This allows oscillation control to be carried out for the oscillation film by area.

Accordingly, the oscillation part of the oscillation film provided in the shape of an array of the fixed electrode (an oscillation area of the oscillation film opposed to the through hole of the fixed electrode) can be divided into plural blocks to control a phase of the alternating current signal so that an acoustic signal different in phase per a block unit is outputted in order to control a direction of a sound to be radiated.

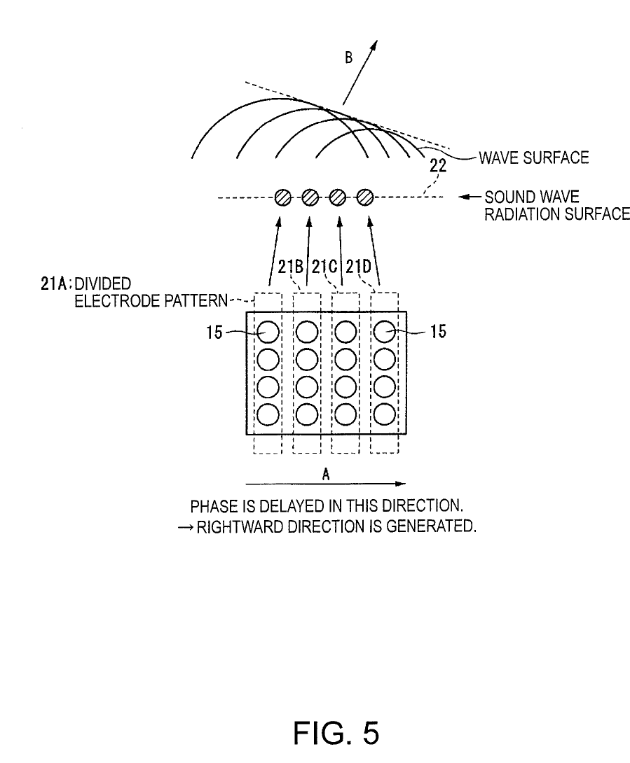

FIG. 5 shows an example of a structure of controlling a direction of the electrostatic ultrasonic transducer. In the example shown in FIG. 5, the electrode for oscillation, which corresponds to the oscillation part 15 of the oscillation film, is divided into four electrode patterns 21A, 21B, 21C and 21D to delay the phases of the alternating current signals in the respective electrode patterns in a direction shown by an arrow A. This allows a wave surface of an acoustic signal radiated from a sound wave radiation surface 22 to be inclined in a direction shown by an arrow B (upward in the drawing) so as to give a directivity.

### Fifth Embodiment

Now, described will be an example of a structure of an ultrasonic speaker using the ultrasonic transducer shown in FIGS. 1A to 1C, FIGS. 3A and 3B, FIGS. 4A to 4D or FIG. 5.

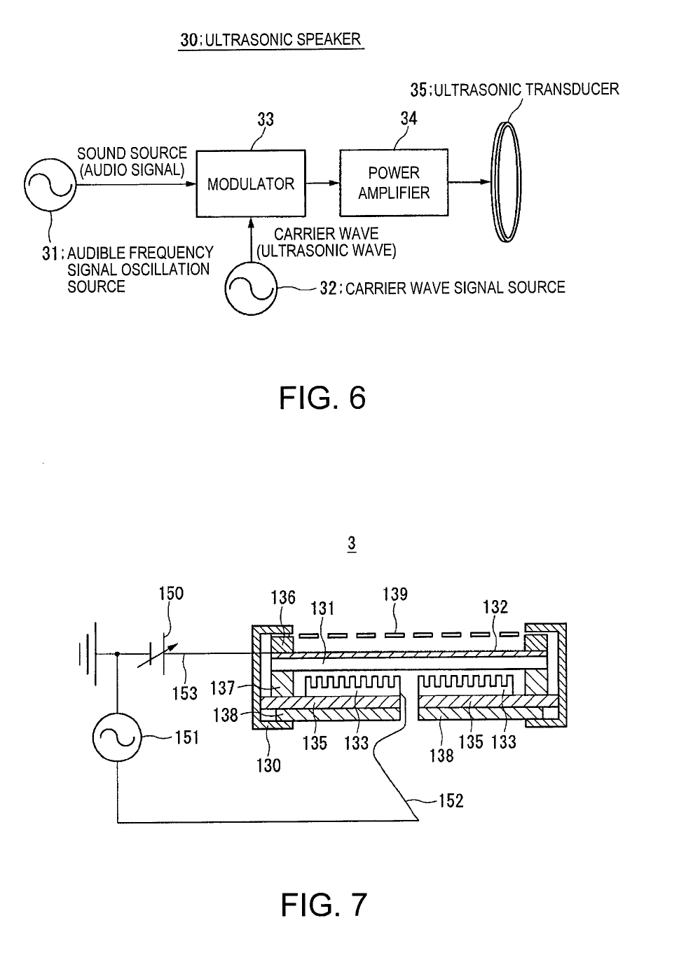

FIG. 6 shows an example of a typical structure of an ultrasonic speaker using the electrostatic ultrasonic transducer in accordance with a fifth embodiment of the invention. In an ultrasonic speaker, an ultrasonic wave called a carrier wave is AM-modulated with an audio signal (an audible area signal) and the AM-modulated ultrasonic wave is radiated into the air to self-reproduce an original audio signal in the air due to non-linearity of the air. That is to say, in a process of transmission of the modulated ultrasonic wave, a part dense with the air and a thin part remarkably appear since the sound wave is a compressional wave transmitted with the air being used as a medium. The sound speed is fast in the dense part while it is slow in the thin part, so that distortion appears in the modulated wave per se. This results in separation of the waveform into a carrier wave (an ultrasonic wave) and an audible wave (the original audio signal) and the human beings can only hear the audible sound (the original audio signal), which is 20 kHz or less. This is a principle used in the ultrasonic speaker and generally called a parametric array effect.

An ultrasonic speaker 30 shown in FIG. 6 comprises an audible frequency wave signal oscillation source (an audio signal source) 31 for generating a signal wave in a frequency band of an audible wave, a carrier wave signal source 32 for generating and outputting a carrier wave in a frequency band of an ultrasonic wave, a modulator 33, a power amplifier 34 and an ultrasonic transducer 35.

The modulator 33 modulates a carrier wave outputted from the carrier wave signal source 32 by means of a signal wave in the frequency band of the audible wave, the signal wave outputted from the audible frequency wave signal oscillation source 31, to supply an ultrasonic transducer 35 with the modulated wave through the power amplifier 34.

In the above structure, a carrier wave in the ultrasonic frequency band, which is outputted from the carrier wave signal source 32, is modulated with the audio signal wave outputted from the audible frequency wave signal oscillation source 31 by means of the modulator 33 to drive the ultrasonic transducer 35 in accordance with a modulated signal amplified in the power amplifier 34. As a result, the modulated signal is converted into a sound wave at a limited amplitude level by means of the ultrasonic transducer 35 and the sound wave is radiated into the medium (into the air) to self-reproduce a signal sound in the original audible frequency band owing to the non-linear effect of the medium (the air). That is to say, a sound wave is a compressional wave transmitted with the air being used as a medium, and therefore, a part dense with the air and a part where the air is thin remarkably appear in a process of transmission of the modulated ultrasonic wave. The sound speed is fast in the dense part while it is slow in the thin part, so that distortion appears in the modulated wave per se. This results in separation into a carrier wave (the ultrasonic frequency band) to reproduce a signal wave (a signal sound) in the frequency band of the audible wave.

In the case of using the ultrasonic transducer shown in FIG. 5, which partially phase-controls drive of the oscillation part arranged in the shape of an array (an oscillation area of the oscillation film opposed to the through hole of the fixed electrode), a circuit for shifting a phase for every divided electrode pattern to perform amplification is included in the power amplifier 34.

As described above, in the electrostatic ultrasonic transducer in accordance with the embodiment of the invention, forming the electrode patterns of the fixed electrode into plural layers allows oscillation control to be performed for the oscillation film area by area. For example, fixing an area other than the oscillation part of the oscillation film only by means of the electrostatic force allows a mutual independent characteristic of the oscillation part arranged into the shape of an array to be improved and influence of distortion to be reduced. Moreover, partially phase-controlling drive of the oscillation part arranged in the shape of an array allows the directivity to be controlled.

Description of Example of Structure of Ultra Directional Acoustic System in Accordance with the Invention

Now, described will be an ultra directional acoustic system using an ultrasonic speaker formed from an electrostatic ultrasonic transducer in accordance with an embodiment of the invention, that is, a push-pull type electrostatic ultrasonic transducer includes: a first electrode provided with a through hole; a second electrode provided with a through hole forming a pair with the through hole of the first electrode; an oscillation film sandwiched between the pair of electrodes and having an electrode layer wherein a direct current bias voltage is applied to the electrode layer, the oscillation film being driven by applying an alternating current signal between the pair of electrodes and the electrode layer; and a holding member for holding the pair of electrodes and the oscillation film, wherein electrode patterns corresponding to plural driving functions are formed on the first and second electrodes, respectively, by lamination, the electrostatic ultrasonic transducer further including: a controlling unit for carrying out control so that voltage corresponding to a driving condition defining the driving function is applied between the electrode pattern formed by lamination and the electrode layer of the oscillation film, or a pull type electrostatic ultrasonic transducer including: an electrode having convex and concave parts on the surface thereof; an oscillation film provided on the surface of the electrode and having an electrode layer wherein a direct current bias voltage is applied to the electrode layer, the oscillation film being driven by applying an alternating current signal between the electrode and the oscillation film; and a member for holding the electrode and the oscillation film, wherein electrode patterns are formed on the electrode by lamination by driving function, the electrostatic ultrasonic transducer further including: a controlling unit for carrying out control so that voltage corresponding to a driving condition defining the driving function is applied between the electrode pattern formed by lamination and the electrode layer of the oscillation film.

A projector will be exemplified hereinafter as an example of the ultra directional acoustic system in accordance with the invention. The ultra directional acoustic system in accordance with the invention is not limited to be applied to a projector but may be widely applied to a display device for reproducing a sound and an image.

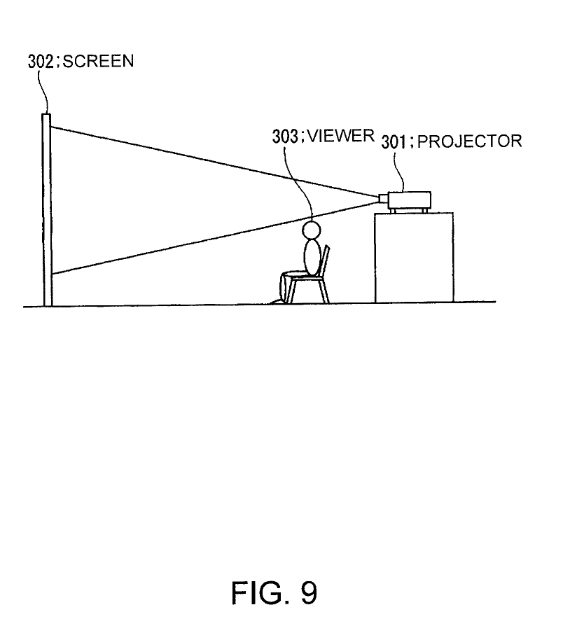

FIG. 9 shows a projector according to the invention, which is in use. As shown in FIG. 9, a projector 301 is provided behind a viewer 303. The projector 301 projects an image on a screen 302 provided on the front of the viewer 303 and forms a virtual sound source on a projection surface of the screen 302 by means of the ultrasonic speaker mounted to the projector 301 to reproduce the sound.

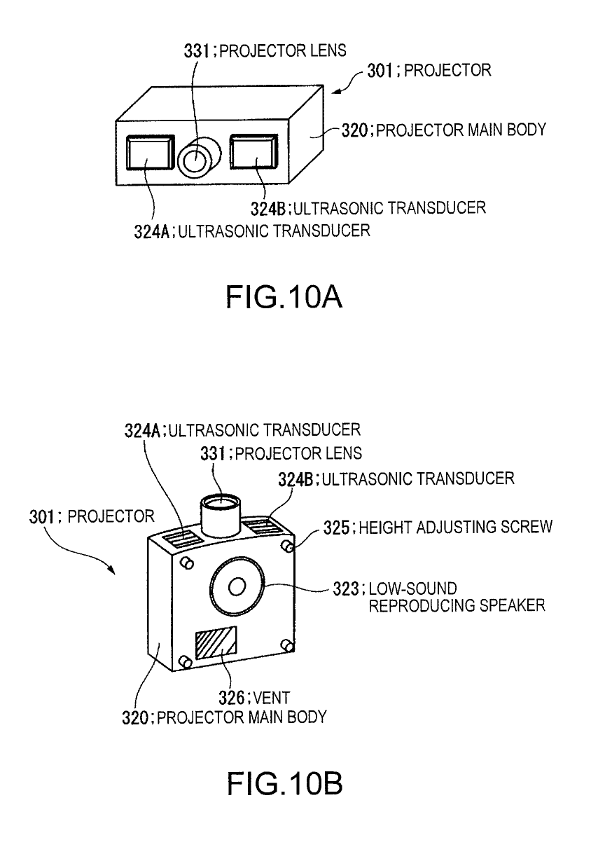

FIGS. 10A and 10B show an appearance of the projector 301. The projector 301 comprises a projector main body 320 including a projection optical system for projecting an image on a projection surface such as a screen and ultrasonic transducers 324A and 324B capable of oscillating a sound wave in the ultrasonic frequency band. The projector 301 is formed in one body with an ultrasonic speaker for reproducing a sound signal in an audible frequency band from a sound signal supplied from an acoustic source. In this embodiment, the ultrasonic transducers 324A and 324B forming the ultrasonic speakers are mounted in the main body of the projector on the left and right sides of a projector lens 331 forming the projection optical system so as to sandwich the projector lens 331 for the purpose of reproducing a stereo sound signal.

Further, on the bottom surface of the projector main body 320, provided is a low-sound reproducing speaker 323. 325 denotes a height adjusting screw for adjusting the height of the projector main body 320. 326 denotes a vent for air-cooling fan.

In the projector 301, used is a push-pull type electrostatic ultrasonic transducer in accordance with the invention as an ultrasonic transducer forming an ultrasonic speaker. An acoustic signal in a wide frequency band (a sound wave in an ultrasonic frequency band) can be thus oscillated at high sound pressure. Accordingly, controlling a spatial reproducing range of a reproduced signal in an audible frequency band by changing the frequency of the carrier wave allows an acoustic effect achieved by means of stereo surround-sound system, 5.1 ch surround-sound system or such to be achieved without a usually required large-scale acoustic system and allows a projector which can be easily carried to be put into practice.

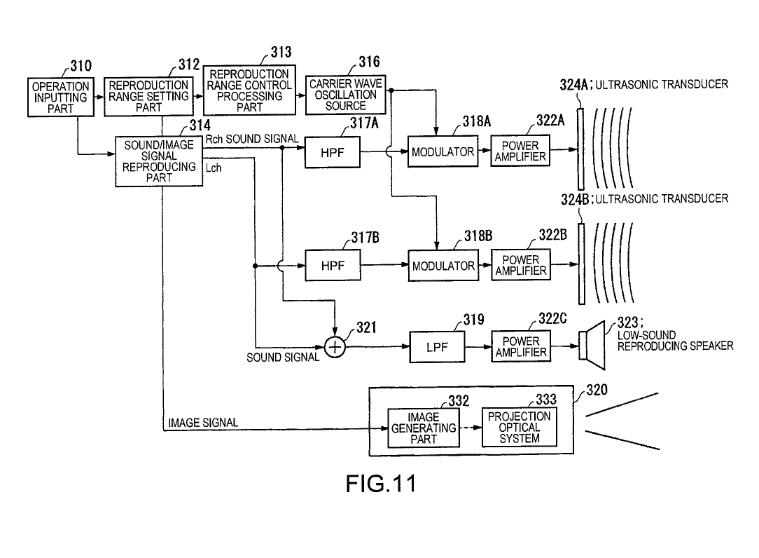

FIG. 11 shows an electrical structure of the projector 301. The projector 301 includes: an operation inputting part 310; an ultrasonic speaker having a reproducing range setting part 312, a reproduction range control processing part 313, a sound/image signal reproducing part 314, a carrier wave oscillation source 316, modulators 318A and 318B, power amplifiers 322A and 322B and electrostatic transducers 324A and 324B; high-pass filters 317A and 317B; a low-pass filter 319; an adder 321; a power amplifier 322C; a low-sound reproducing speaker 323; and a projector main body 320. The electrostatic ultrasonic transducers 324A and 324B are a push-pull type electrostatic ultrasonic transducer in accordance with the invention.

The projector main body 320 includes an image generating part 332 for generating an image and a projection optical-system 333 for projecting the generated image on a projection surface. The projector 301 comprises the ultrasonic speaker, the low-sound reproducing speaker 323 and the projector main body 320, which are formed into one body.

The operation inputting part 310 has various kinds of function keys including a numeric keypad, numeric keys and a power source key for turning on and off the power source. The reproduction range setting part 312 is arranged to be able to input data for designating a reproduced range of a reproduction signal (a signal sound) by a key operation of the operation inputting part 310 by a user. It is arranged that a frequency of the carrier wave defining the reproduction range of the reproduced signal be set and kept when the data is inputted. Designating the distance from a sound wave radiating surface of the ultrasonic transducers 324A and 324B to a point where the reproduced signal arrives in a direction of a radiating axis allows the reproduction range of the reproduction signal to be set.

The reproduction range setting part 312 is also arranged to be able to set a frequency of the carrier wave by means of the controlling signal outputted from the sound/image signal reproducing part 314 in accordance with contents of an image.

The reproduction range controlling process part 313 has a function of referring the contents set by means of the reproduction range setting part 312 to control the carrier wave oscillation source 316 to change a frequency of the carrier wave generated by the carrier wave oscillation source 316 so that the frequency of the carrier wave falls in the set reproduction range.

For example, in the case that the distance corresponding to 50 kHz of the carrier wave frequency is set as inner information of the reproduction range setting part 312, the carrier wave oscillation source 316 is controlled to perform oscillation at 50 kHz.

The reproduction range control processing part 313 includes a storing part in which a table showing a relation between the distance from a sound wave radiating surface of the ultrasonic transducers 324A and 324B to a point where the reproduced signal arrives in a direction of a radiating axis, the distance designating the reproduction range, and the frequency of the carrier wave is stored in advance. The data of the table can be obtained by practically measuring the relation between the frequency of the carrier wave and the distance that the reproduced signal reaches.

The reproduction range control processing part 313 calculates the frequency of the carrier wave corresponding to the distance information set with reference to the table on the basis of the contents set by means of the reproduction range setting part 312 to control the carrier wave oscillation source 316 to achieve the frequency.

The sound/image signal reproducing part 314 is a DVD player using a DVD as an image media, for example. Among the reproduced signals, the sound signal in the R channel is outputted to the modulator 318A through the high-pass filter 317A, the sound signal in the L channel is outputted to the, modulator 318B through the high-pass filter 317B and the image signal is outputted to the image generating part 332 of the projector main body 320.

The sound signals in the R channel and the L channel, which are outputted from the sound/image signal reproducing part 314, are compounded in the adder 321 to be inputted to the power amplifier 332C through the low-pass filter 319. The image/sound signal reproducing part 314 corresponds to the acoustic source.

The high-pass filters 317A and 317B have a characteristic that the frequency components of the sound signals in the R and L channels in the middle and high sound range only pass through the high-pass filters, respectively. The low-pass filter has a characteristic that the frequency components of the sound signals in the R and L channels in the low sound range only pass through the low-pass filter.

Accordingly, the sound signals in the R and L channels in the middle and high sound range are reproduced by means of the ultrasonic transducers 324A and 324B, respectively, while the sound signals in the R and L channels in the low sound range are reproduced by means of the low-sound reproducing speaker 323.

The sound/image signal reproducing part 314 is not limited to a DVD player but may be a reproducing apparatus for reproducing a video signal inputted from the outside. The sound/image signal reproducing part 314 has a function of outputting a controlling signal for instructing the reproduction range setting part 312 on the reproduction range so that the reproduction range of the reproduced sound is dynamically changed for the purpose of achieving an acoustic effect corresponding to a scene of an image to be reproduced.

The carrier wave oscillation source 316 has a function of generating a carrier wave having a frequency in the ultrasonic frequency band, which is directed by the reproduction range setting part 312, to output the generated carrier wave to the modulators 318A and 318B.

The modulators 318A and 318B have a function of AM-modulating the carrier wave supplied from the carrier wave oscillation source 316 with the sound signals in the audible frequency band, the sound signals outputted from the sound/image signal reproducing part 314, to output the modulated signals to the power amplifiers. 322A and 322B, respectively.

The ultrasonic transducer 324A and 3243 are driven in accordance with the modulated signals outputted from the modulators 318A and 318B through the power amplifiers 322A and 322B, respectively. The ultrasonic transducer 324A and 324B have a function of converting the modulated signals into the sound wave at the limited amplitude level and radiating the same into a medium to reproduce a signal sound in the audible frequency band (a reproduced sound).

The image generating part 332 includes a display such as a liquid crystal display or a plasma display panel (PDP) and a driving circuit for driving the display on the basis of an image signal outputted from the image/sound reproducing part 314. The image generating part 332 generates an image obtained from an image signal outputted from the sound/image signal reproducing part 314.

The projection optical system 333 has a function of projecting an image displayed on the display on a projection surface such as a screen provided in the front of the projector main body 320.

Now, an operation of the projector 301 having the above structure will be described. First, a user operates a key to set the data designating the reproduction range of a reproduced signal (the distance information) in the reproduction range setting part 312 through the operation inputting part 310. The sound/image signal reproducing part 314 is instructed to carry out reproduction.

This results in setting of the distance information defining the reproduction range in the reproduction range setting part 312. The reproduction range control processing part 313 takes in the distance information set in the reproduction range setting part 312, refers the table stored in the built-in storing part, calculates the frequency of the carrier wave corresponding to the set distance information and controls the carrier wave oscillation source 316 to generate the carrier wave having the frequency.

As a result, the carrier wave oscillation source 316 generates the carrier wave having the frequency corresponding to the distance information set in the reproduction range setting part 312 to output the generated carrier wave to the modulators 318A and 318B.

On the other hand, the sound/image signal reproducing part 314 outputs the reproduced sound signal in the R channel to the modulator 318A through the high-pass filter 317A, the reproduced sound signal in the L channel to the modulator 318B through the high-pass filter 317B, the sound signals in the R and L channels to the adder 321 and the image signal to the image generating part 332 of the projector main body 320.

Accordingly, the sound signal in the R channel in the middle and high sound range is inputted to the modulator 318A through the high-pass filter 317A while the sound signal in the L channel in the middle and high sound range is inputted to the modulator 318B through the high-pass filter 317B.

The sound signals in the R and L channels are composed by means of the adder 321. The sound signals in the R and L channels in the low sound range are inputted to the power amplifier 322C through the low-pass filter 319.

The image generating part 332 drives the display on the basis of the inputted image signal to generate and display an image. The image displayed on the display is projected on a projection surface, a screen 302 shown in FIG. 9, for example, by means of the projection optical system 333.

On the other hand, the modulator 318A AM-modulates the carrier wave outputted from the carrier wave oscillation source 316 with the sound signal in the R channel in the middle and high sound range, which is outputted from the high-pass filter 317A, to output the modulated signal to the power amplifier 322A.

The modulator 318B AM-modulates the carrier wave outputted from the carrier wave oscillation source 316 with the sound signal in the L channel in the middle and high sound range, which is outputted from the high-pass filter 317B, to output the modulated signal to the power amplifier 322B.

The modulated signals amplified by means of the power amplifiers 322A and 322B are respectively applied between the upper electrodes 10A and the lower electrodes 10B (refer to FIGS. 1A to 1C) of the ultrasonic transducers 324A and 324B. The modulated signals are converted into a sound wave at a limited amplitude level (acoustic signals) to be radiated in the medium (in the air). The sound signal in the R channel in the middle and high sound range is reproduced by means of the ultrasonic transducer 324A while the sound signal in the L channel in the middle and high sound range is reproduced by means of the ultrasonic transducer 324B.

The sound signals in the R and L channels in the low sound range, which have been amplified by means of the power amplifier 322C, are reproduced by means of the low-sound reproducing speaker 323.

As described above, in transmission of an ultrasonic wave radiated in the medium (in the air) by means of an ultrasonic transducer, the sound speed is fast at a part where the sound pressure is high while it is slow at a part where the sound pressure is low, in accordance with the transmission. This results in generation of distortion of a waveform.

In the case that a signal (a carrier wave) in an ultrasonic frequency band, which is to be radiated, has been modulated (AM-modulated) with a signal in an audible frequency band, a signal wave of the audible frequency band used in modulation is formed so that it would be separated from the carrier wave of the ultrasonic frequency band and self-demodulated as a result of the distortion of the waveform. At that time, the reproduced signals spread in the shape of a beam due to a characteristic of the ultrasonic wave, so that a sound is reproduced only in a specific direction entirely different from a usual speaker.

The beam-shaped reproduced signal outputted from the ultrasonic transducer 324 forming an ultrasonic speaker is radiated to the projection surface (a screen) on which an image is projected by means of the projection optical system 333. The radiated signal is reflected on the projection surface to be scattered. In this case, the reproduction range varies since the beam width (an angle that the beam spreads) of the carrier wave is different in accordance with the frequency of the carrier wave set in the reproduction range setting part 312 in the distance from the sound wave radiating surface of the ultrasonic transducer 324 to a point where the reproduced signal is separated from the carrier wave in a direction of a radiation axis (in a direction of a normal).

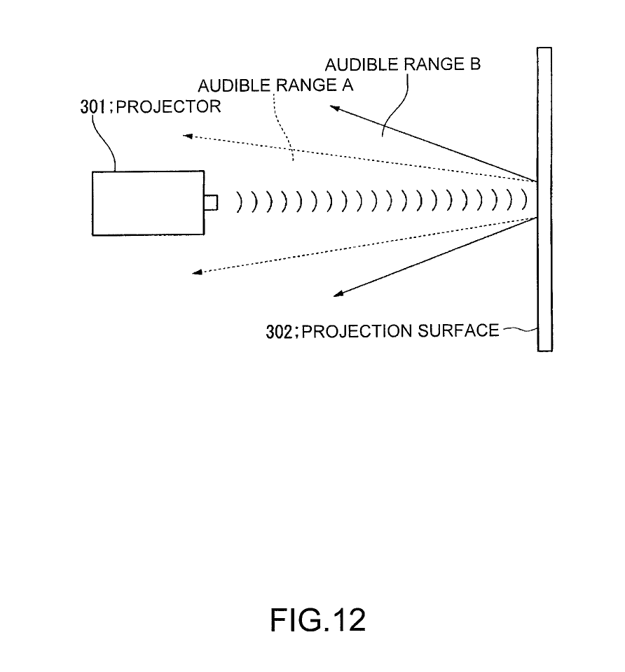

FIG. 12 shows the reproduced signal in reproduction from the ultrasonic speaker including the ultrasonic transducers 324A and 324B in the projector 301. In the projector 301, when the carrier frequency set by means of the reproduction range setting part 312 is low in driving the ultrasonic transducer on the basis of the modulated signal formed from the carrier wave modulated with the sound signal, the distance from the sound wave radiation surface of the ultrasonic transducer 324 to a point where the reproduced signal is separated from the carrier wave in a direction of the radiation axis (in a direction of a normal of the sound wave radiation surface), namely, the distance to the reproduction point becomes long.

Accordingly, a reproduced beam of the reproduced signal in the audible frequency band reaches the projection surface (the screen) 302 with little spreading and is reflected on the projection surface 302 in this condition. The reproduction range is thus an audible range A shown by an arrow in a dotted line in FIG. 12. The reproduced signal (the reproduced sound) can be hear only in a narrow range comparatively far from the projection surface 302.

On the other hand, when the carrier frequency set by means of the reproduction range setting part 312 is higher than the above-mentioned case, the sound wave radiated from the sound wave radiation surface of the ultrasonic transducer 324 is narrowed down more than the case of the low carrier frequency. The distance from the sound wave radiation surface of the ultrasonic transducer 324 to a point where the reproduced signal is separated from the carrier wave in a direction of the radiation axis (in a direction of a normal of the sound wave radiation surface), namely, the distance to the reproduction point, however, becomes short.

Accordingly, a reproduced beam of the reproduced signal in the audible frequency band spreads before reaching the projection surface 302, and then, reaches the projection surface 302. The reflection is carried out on the projection surface 302 in this condition. Accordingly, the reproduction range is an audible range B shown by an arrow in a solid line in FIG. 12. The reproduced signal (the reproduced sound) can be hear only in a wide range comparatively close to the projection surface 302.

As described above, in the projector in accordance with the invention, used is an ultrasonic speaker using a push-pull or pull type electrostatic ultrasonic transducer according to the invention and an acoustic signal can be reproduced with a sufficient sound pressure and a wide band characteristic so as to be generated from a virtual sound source formed in the vicinity of the sound wave reflection surface such as a screen. This allows control of the reproduction range to be easily performed. Further, as described above, in the electrostatic ultrasonic transducer, an oscillation area of the oscillation film is divided into plural blocks to drive-control a phase of the alternating current signal applied between the electrode layer of the oscillation film and the respective blocks of the electrode patterns for oscillation so that each predetermined difference in phase exist between adjacent blocks in order to control a direction of a sound radiated from the ultrasonic speaker.

The embodiments of the invention have been described above. The electrostatic ultrasonic transducer and the ultrasonic speaker in accordance with the invention, however, are not limited only to the examples shown in the drawings. Various kinds of modification can be made, of course, within a range not deviating from the spirit of the invention.

The ultrasonic transducer in accordance with the embodiment of the invention is applicable to various kinds of sensors such as a distance measuring sensor, for example, as well as a sound source for a directional speaker and an ideal impulse signal generating source as described above. It is also useful for an ultra directional acoustic system and a display device such as a projector.

What is claimed is:

1. An electrostatic ultrasonic transducer comprising:
a first electrode including a through hole and plural electrode patterns;
a second electrode including a through hole forming a pair with the through hole of the first electrode and plural electrode patterns forming a pair with the electrode patterns;
an oscillation film including an electrode layer and sandwiched between a pair of electrodes formed from the first electrode and the second electrode; and
a controlling unit for applying voltage between the electrode patterns of the pair of electrodes and the electrode layer of the oscillation film to drive the oscillation film under plural driving conditions.

2. The electrostatic ultrasonic transducer according to claim 1, wherein
the electrode comprises:
an electrode pattern for oscillation for oscillating the oscillation film; and
an electrode pattern for fixing for fixing the oscillation film to the pair of electrodes, and
the controlling unit applies voltage between the electrode layer of the oscillation film and the electrode pattern for fixing so that a part of the oscillation film would be fixed to the pair of electrodes in oscillating the oscillation film.

3. The electrostatic ultrasonic transducer according to claim 2, wherein
the electrode pattern for oscillation is divided so that the oscillation film would be divided into plural blocks for drive and
the controlling unit controls a phase of an alternating current signal applied between the electrode layer of the oscillation film and each block of the electrode pattern for oscillation so as to give a predetermined difference in phase between the respective adjacent blocks in oscillating the oscillation film.

4. An electrostatic ultrasonic transducer comprising:
an electrode including plural electrode patterns and including convex and concave parts on the surface thereof;
an oscillation film including an electrode layer and held on the surface of the electrode; and
a controlling unit for applying voltage between the electrode pattern of the electrode and the electrode layer of the oscillation film to drive the oscillation film under plural driving conditions.

5. The electrostatic ultrasonic transducer according to claim 4, wherein
the electrode comprises:
an electrode pattern for oscillation for oscillating the oscillation film; and
an electrode pattern for fixing for fixing the oscillation film to the electrode, and
the controlling unit applies voltage between the electrode layer of the oscillation film and the electrode pattern for fixing so that a part of the oscillation film would be fixed to the electrode in oscillating the oscillation film.

6. The electrostatic ultrasonic transducer according to claim 5, wherein
the electrode pattern for oscillation is divided so that the oscillation film would be divided into plural blocks for drive and
the controlling unit controls a phase of an alternating current signal applied between the electrode layer of the oscillation film and each block of the electrode pattern for oscillation so as to give-a predetermined difference in phase between the respective adjacent blocks in oscillating the oscillation film.

7. An ultrasonic speaker comprising the electrostatic ultrasonic transducer according to claim 1.

8. An ultrasonic speaker comprising the electrostatic ultrasonic transducer according to claim 4.

9. A method of reproducing a sound signal by means of an electrostatic ultrasonic transducer, using the electrostatic ultrasonic transducer according to claim 1,
the method comprising:
generating a signal wave in an audible frequency band by means of a signal source;
generating a carrier wave in an ultrasonic frequency band by means of a carrier wave supplying source;
generating a modulated signal obtained by modulating the carrier wave with the signal wave in the audible frequency band; and
applying the modulated signal between the e electrode and the electrode layer of the oscillation film to drive the electrostatic ultrasonic transducer.

10. A method of reproducing a sound signal by means of an electrostatic ultrasonic transducer, using the electrostatic ultrasonic transducer according to claim 4,
the method comprising:
generating a signal wave in an audible frequency band by means of a signal source;
generating a carrier wave in an ultrasonic frequency band by means of a carrier wave supplying source;
generating a modulated signal obtained by modulating the carrier wave with the signal wave in the audible frequency band; and
applying the modulated signal between the electrode and the electrode layer of the oscillation film to drive the electrostatic ultrasonic transducer.

11. An ultra directional acoustic system for reproducing a sound signal supplied from an acoustic source to form a virtual sound source in the vicinity of a sound wave reflection surface such as a screen by means of an ultrasonic speaker using the electrostatic ultrasonic transducer according to claim 1, the ultra directional acoustic system comprising:
an ultrasonic speaker for reproducing a signal in a middle and high sound range among sound signals supplied from the acoustic source; and
a low-sound reproducing speaker for reproducing a sound in a low sound range among the sound signals supplied from the acoustic source.

12. An ultra directional acoustic system for reproducing a sound signal supplied from an acoustic source to form a virtual sound source in the vicinity of a sound wave reflection surface such as a screen by means of an ultrasonic speaker using the electrostatic ultrasonic transducer according to claim 4, the ultra directional acoustic system comprising:
an ultrasonic speaker for reproducing a signal in a middle and high sound range among sound signals supplied from the acoustic source; and
a low-sound reproducing speaker for reproducing a sound in a low sound range among the sound signals supplied from the acoustic source.

13. A display device including the electrostatic ultrasonic transducer according to claim 1, comprising:
an ultrasonic speaker for reproducing a signal sound in an audible frequency band from sound signals supplied from an acoustic source; and
a projection optical system for projecting an image on a projection surface.

14. A display device including the electrostatic ultrasonic transducer according to claim 4, comprising:
an ultrasonic speaker for reproducing a signal sound in an audible frequency band from sound signals supplied from an acoustic source; and
a projection optical system for projecting an image on a projection surface.
